(19) United States
(12) Patent Application Publication
(10) Pub. No.: US 2025/0379261 A1
(43) Pub. Date: Dec. 11, 2025

(54) Lithium Ion Battery

(71) Applicant: TOYOTA JIDOSHA KABUSHIKI KAISHA, Toyota-shi Aichi-ken (JP)

(72) Inventor: Aiko NAGANO, Nisshin-shi Aichi-ken (JP)

(73) Assignee: TOYOTA JIDOSHA KABUSHIKI KAISHA, Toyota-shi Aichi-ken (JP)

(21) Appl. No.: 19/224,024

(22) Filed: May 30, 2025

(30) Foreign Application Priority Data
Jun. 5, 2024 (JP) 2024-091322

(51) Int. Cl. H01M 10/0585; H01M 10/0525

(52) U.S. Cl. CPC H01M 10/0585; H01M 10/0525

(57) ABSTRACT

A lithium ion battery comprises an electrolyte solution and a stacked electrode assembly. The stacked electrode assembly includes a positive electrode layer and a negative electrode layer. The positive electrode layer and the negative electrode layer are alternately stacked in a stacking direction. In the stacking direction, the stacked electrode assembly includes a first region, a second region, and a third region in this order. The second region includes an intermediate point in the stacking direction. The first region includes a first positive electrode active material having a first particle size. Each of the second region and the third region includes a second positive electrode active material having a second particle size and a third positive electrode active material having a third particle size. A relationship of “d₂<d₁<d₃” is satisfied. “d₁” represents the first particle size. “d₂” represents the second particle size. “d₃” represents the third particle size.

### CROSS REFERENCE TO RELATED APPLICATIONS

This nonprovisional application is based on Japanese Patent Application No. 2024-091322 filed on Jun. 5, 2024, with the Japan Patent Office, the entire contents of which are hereby incorporated by reference.

### BACKGROUND

### Field

The present disclosure relates to a lithium ion battery.

### Description of the Background Art

Japanese Patent Laying-Open No. 2018-106981 discloses that the permeability coefficient of the electrolyte solution is changed in the in-plane direction of the positive electrode layer by adjusting the binder distribution in the positive electrode layer.

### SUMMARY

The “permeability coefficient” indicates the mobility of the electrolyte solution in the positive electrode layer. It is considered that the larger the permeability coefficient, the more easily the electrolyte solution moves in the positive electrode layer. For example, it has been proposed to provide a region having a small permeability coefficient at the end of the positive electrode layer in the in-plane direction. The region damms the electrolyte solution, so that the amount of the electrolyte solution flowing out from the positive electrode layer can be reduced. For example, an improvement in high-rate resistance is expected by a reduction in the outflow amount of the electrolyte solution.

The positive electrode layer may include a positive electrode active material and a binder. For example, it has been proposed to adjust the permeability coefficient by the shading of the binder amount in the in-plane direction. However, when the permeability coefficient is adjusted by the method, it is considered that the quality variation is likely to occur. As a result, the productivity and performance of the battery may be degraded. Furthermore, there is still room for improvement in high-rate tolerance.

It is an object of the present disclosure to improve high-rate tolerance.

1. A lithium ion battery comprises an electrolyte solution and a stacked electrode assembly. The stacked electrode assembly includes a positive electrode layer and a negative electrode layer. The positive electrode layer and the negative electrode layer are alternately stacked in a stacking direction. In the stacking direction, the stacked electrode assembly includes a first region, a second region, and a third region in this order. The second region includes an intermediate point in the stacking direction. The first region includes a first positive electrode active material having a first particle size. Each of the second region and the third region includes a second positive electrode active material having a second particle size and a third positive electrode active material having a third particle size. A relationship of “d₂<d₁<d₃” is satisfied. “d₁” represents the first particle size. “d₂” represents the second particle size. “d₃” represents the third particle size.

The particle size of the positive electrode active material may be correlated with the amount of voids in the positive electrode layer. That is, the particle size of the positive electrode active material may be a control factor of the permeability coefficient. When the relationship of “d₂<d₁<d₃” is satisfied, the permeability coefficients in the second region and the third region tend to be larger than the permeability coefficient in the first region. The first region, the second region, and the third region are arranged in the stacking direction. In the first region, it is considered that since the electrolyte solution is unlikely to flow out from the positive electrode layer, lithium (Li) ions in the electrolyte solution are unlikely to decrease. On the other hand, in the second region and the third region, entry and exit of the electrolyte solution into and from the positive electrode layer are promoted. In the second region and the third region, Li ions of the electrolyte solution that once flowed out of the positive electrode layer can also be effectively utilized. The synergy of these effects is expected to improve high-rate tolerance.

2. The lithium ion battery described in the above item “1” may include, for example, the following configuration. A relationship of “d₃/d₂≤2.2” is satisfied.

When the relationship of “d₃/d₂≤2.2” is satisfied, the permeability coefficients of the second region and the third region tend to increase.

3. The lithium ion battery described in the item “1” or “2” may include, for example, the following configuration. Relationships of “p₁<p₂” and “p₁<p₃” are satisfied. “p₁” represents a permeability coefficient of the electrolyte solution with respect to the positive electrode layer in the first region. “p₂” represents a permeability coefficient of the electrolyte solution with respect to the positive electrode layer in the second region. “p₃” represents a permeability coefficient of the electrolyte solution with respect to the positive electrode layer in the third region.

4. The lithium ion battery according to any one of the above items “1” to “3” may include, for example, the following configuration. A relationship of “1≤n₂≤0.5(n₁+n₂+n₃)” is satisfied. “n₁” represents the number of the positive electrode layers included in the first region. “n₂” represents the number of the positive electrode layers included in the second region. “n₃” represents the number of the positive electrode layers included in the third region.

The second region is not limited to one positive electrode layer located in the middle in the stacking direction. The second region may have a range over the plurality of positive electrode layers in the stacking direction.

5. The lithium ion battery described in the above item “3” may include, for example, the following configuration. Relationships of 1×10⁻¹⁶ m²<p₁<1×10⁻¹⁴ m², 1×10⁻¹⁴ m²<p₂<1×10⁻¹³ m², and 1×10⁻¹⁴ m²<p₃<1×10⁻¹³ m² are satisfied.

Hereinafter, one embodiment of the present disclosure (Hereinafter, it may be abbreviated as “the present embodiment”.) and one example of the present disclosure (Hereinafter, it can be abbreviated as “the present example”.) will be described. However, the present embodiment and the present example do not limit the technical scope of the present disclosure. The present embodiment and the present example are illustrative in all respects. The present embodiments and examples are non-limiting. The technical scope of the present disclosure includes all modifications within the meaning and range equivalent to the description of the claims. For example, any configuration is extracted from the present embodiment, and it is also planned from the beginning that they are freely combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram showing an example of a lithium ion battery according to the present embodiment.

FIG. 2 is a graph showing a rectangular wave in a high-rate endurance test.

FIG. 3 is a graph showing the results of a high-rate endurance test.

FIG. 4 is a graph showing a correlation between a pore diameter and a permeability coefficient in a positive electrode layer.

FIG. 5 is a graph showing a first pore size distribution.

FIG. 6 is a table showing the relationship between the particle size ratio and the permeability coefficient in the positive electrode layer.

FIG. 7 is a graph showing a relationship between a particle diameter ratio and a permeability coefficient in a positive electrode layer.

FIG. 8 is a graph showing a second pore size distribution.

FIG. 9 is a graph showing the correlation between the pore diameter of the positive electrode layer and the permeability coefficient.

FIG. 10 is a graph showing the correlation between the porosity of the positive electrode layer and the permeability coefficient.

### DESCRIPTION OF THE EMBODIMENTS

### Terms and Phrases

Geometric terms are not to be construed in a strict sense. Examples of geometric terms include “parallel”, “perpendicular”, and “orthogonal”. For example, directions, angles, distances, and the like may be relatively displaced within a range in which substantially the same or similar functions are obtained. Geometric terms may include, for example, design, work, manufacturing, etc. tolerances, errors, etc. The dimensional relationship in each drawing may not coincide with the actual dimensional relationship. To aid the reader's understanding, the dimensional relationships in the figures may be varied. For example, the length, width, thickness, and the like may be changed. Some components may be omitted.

Numerical ranges such as “m to n %” include upper and lower limits unless otherwise specified. That is, “m to n %” indicates a numerical range of “m % or more and n % or less”. Further, “m % or more and n % or less” includes “more than m % and less than n %”. The expressions “or more” and “or less” are represented by an inequality sign “>, >” with an equal sign. The “more than” and “less than” are represented by an inequality sign “<, >” which does not include an equal sign. A numerical value freely selected from the numerical range may be set as a new upper limit value or lower limit value. For example, a new numerical value range may be set by freely combining a numerical value within the numerical value range with a numerical value described in another part, a table, a drawing, or the like in the present specification.

Hereinafter, for example, the “permeability coefficient of the electrolyte solution with respect to the positive electrode layer” is also referred to as “permeability coefficient of the positive electrode layer”. The “permeability coefficient” indicates a value measured by the following method. First, a tomographic image of the positive electrode layer is acquired by FIB-SEM (Focused Ion Beam Scanning Electron Microscopy). A three-dimensional structure is reconstructed from the tomographic image. A finer tomographic pitch is desirable. It is desirable that the imaging area be large. For example, the following conditions may be adopted from the viewpoint of the device specification and the measurement time of the FIB-SEM.
Tomographic pitch: 100 nm (It may be smaller than 100 nm.)
Imaging area size: 50 μm×30 μm (It may be greater than 50 μm by 30 μm.)
Magnification: in the case where the particle (solid) and the void can be distinguished from each other with the imaging area size as it is, the magnification as it is is employed. When the particles and the voids cannot be distinguished from each other, the magnification is adjusted with a magnification of three times or more the diameter of the particles as a reference.
Number of slices: 200 sheets (More than 200 sheets may be used.).
Cross-sectional Samples: the cross-sectional sample may be embedded in a resin so that particles and voids are easily distinguished.

The three-dimensional structure is then analyzed. The permeability coefficient is calculated from the three-dimensional structure by the analysis module “FlowDict” of the simulation software “GeoDict” (manufactured by Math 2 Market). The permeability coefficient is derived using the Stokes equation or the Navier-Stokes equation. Whether to select the Stokes equation or the Navier-Stokes equation may be determined based on actual measurement data (the relationship between the pressure and the flow rate in the positive electrode layer). If the relationship between pressure and flow rate is linear, the Stokes equation is considered appropriate. If the relationship between pressure and flow rate is nonlinear, the Navier-Stokes equation is considered appropriate. Since the permeability coefficient in the in-plane direction of the positive electrode layer is a target, the X-axis or the Y-axis is selected as the axial direction in which the fluid flows. The X-axis or the Y-axis is selected based on the cutting direction of the cross-sectional sample. For example, “the permeability coefficient of the negative electrode layer” may be similarly measured.

The “particle size” is measured by microscopy. That is, the particle size indicates the particle size of the peak top in the particle size distribution on the number basis measured in the cross-sectional SEM image of the positive electrode layer. In the cross-sectional SEM image, the particle size indicates the maximum Feret diameter. The “maximum Feret diameter” indicates the distance between the two farthest points on the contour of the particle. The particle size distribution is created from 100 or more particle sizes. For example, if the particle size distribution is unimodal, the particle size of the peak top is considered the particle size (d₁) of the medium particles. For example, if the particle size distribution is multimodal, the highest peak and the second height peak are extracted. Of the two peaks, the smaller the particle size, the smaller the particle size (d₂) of the small particle. A larger particle size is regarded as a larger particle size (d₃).

### Lithium Ion Battery

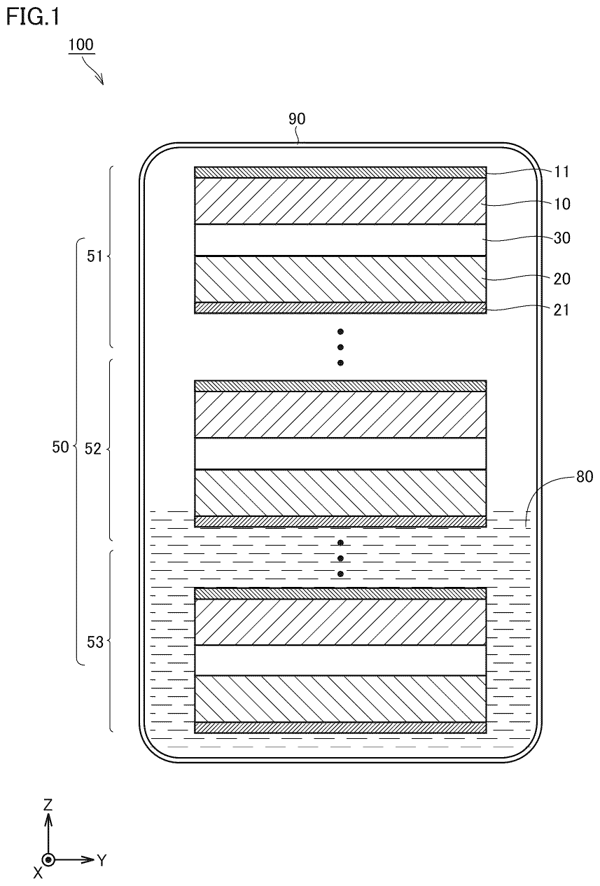

FIG. 1 is a conceptual diagram showing an example of a lithium ion battery according to the present embodiment. The battery 100 is a lithium ion battery. The battery 100 includes an electrolyte solution 80 and a stacked electrode assembly 50. The battery 100 may include an exterior package 90. The exterior package 90 may contain the electrolyte solution 80 and the stacked electrode assembly 50. The exterior package 90 may have any form. The exterior package 90 may be, for example, a metal case or a pouch made of a metal foil laminate film. In the exterior package 90, the electrolyte solution 80 may be stored vertically downward, for example.

### Stacked Electrode Assembly

The stacked electrode assembly 50 can be referred to as, for example, a “power generation element” or the like. The stacked electrode assembly 50 may have a bipolar structure or a monopolar structure. The stacked electrode assembly 50 includes a positive electrode layer 10 and a negative electrode layer 20. The stacked electrode assembly 50 may further include a separator 30. The separator 30 is disposed between the positive electrode layer 10 and the negative electrode layer 20. The stacked electrode assembly 50 has a stacking direction. In FIG. 1, the stacking direction is the Z direction. The stacking direction may be, for example, along the vertical direction. The stacking direction may be parallel to the vertical direction, for example. The positive electrode layers 10 and the negative electrode layers 20 are alternately stacked in the stacking direction.

In the stacking direction, the stacked electrode assembly 50 includes a first region 51, a second region 52, and a third region 53 in this order. The second region 52 includes an intermediate point in the stacking direction. For example, the first region 51 may be adjacent to the second region 52. For example, the second region 52 may be adjacent to the third region 53. For example, each region may be continuous. For example, the first region 51 may include one end in the stacking direction. For example, the third region 53 may include the other end in the stacking direction.

For example, the first region 51 may be located vertically above the second region 52. For example, the second region 52 may be located vertically above the third region 53. For example, at least a part of the third region 53 may be immersed in the electrolyte solution 80. That is, the third region 53 may be in contact with the excess liquid. For example, at least a part of the second region 52 may also be immersed in the electrolyte solution 80. For example, the first region 51 may be separated from the excess liquid.

Each region includes one or more positive electrode layers 10. The first region 51 includes a first positive electrode active material. That is, the positive electrode layer 10 included in the first region 51 includes the first positive electrode active material. The first positive electrode active material has a first particle size “d₁”.

The second region 52 includes a second positive electrode active material and a third positive electrode active material. That is, the positive electrode layer 10 included in the second region 52 includes the second positive electrode active material and the third positive electrode active material. The second positive electrode active material has a second particle size “d₂”. The third positive electrode active material has a third particle size “d₃”. The third region 53 also includes the second positive electrode active material and the third positive electrode active material. That is, the positive electrode layer 10 included in the third region 53 includes the second positive electrode active material and the third positive electrode active material.

The particle sizes of the first positive electrode active material, the second positive electrode active material, and the third positive electrode active material satisfy the relationship of “d₂<d₁<d₃”. The relationship of “d₂<d₁<d₃” is derived from the results of the following first experiment and second experiment.

### First Experiment (For Permeability Coefficient in Each Region)

An evaluation cell (lithium ion battery) including the stacked electrode assembly 50 described below was produced.
Positive electrode Layer 10: positive electrode active material (lithium-nickel-cobalt-manganese composite oxide)
Negative electrode Layer 20: negative electrode active material (graphite)
Number of stacked electrodes: 30

Three kinds of positive electrode layers 10 were prepared. The three types of positive electrode layers 10 have different permeability coefficients. The permeability coefficient was adjusted by the magnitude of the pressure at the time of press working on the positive electrode layer 10.
Permeability coefficient “L”: 6×10⁻¹⁴ m²
Permeability coefficient “M”: 3×10⁻¹⁵ m²
Permeability coefficient “S”: 8×10⁻¹⁶ m²

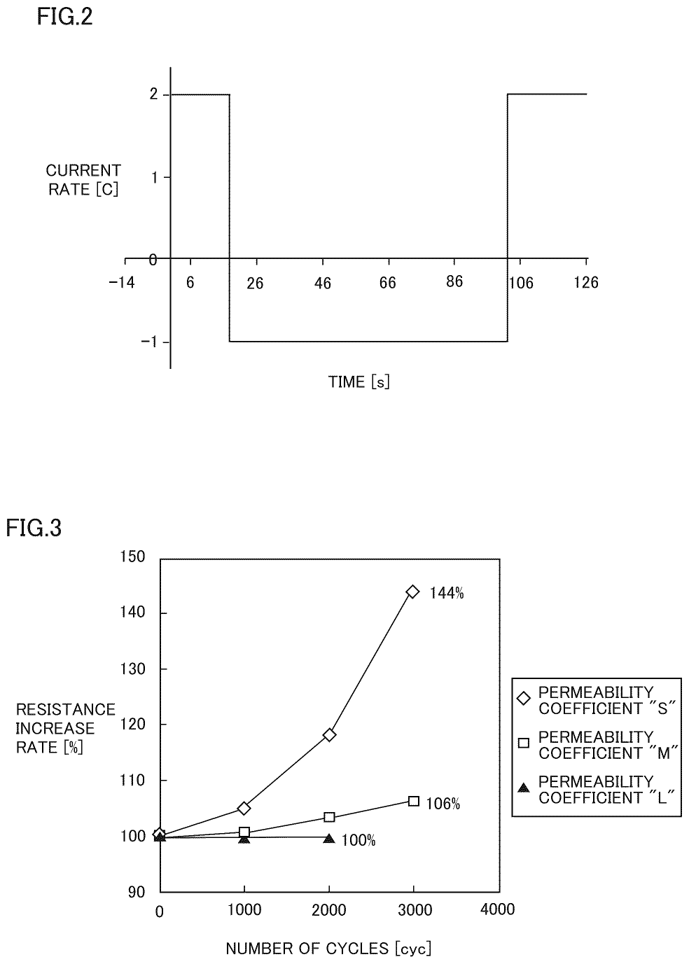

The evaluation cell was subjected to a high-rate durability test. FIG. 2 is a graph showing a rectangular wave in a high-rate endurance test. The rectangular wave includes the following first step, second step, and third step in this order.
First Step: charge (current rate=2 C, charge time=18 seconds)
Second Step: discharge (current rate=1 C, charge time=84 seconds)
Third Step: charge (current rate=2 C, charge time=24 seconds)

Note that “C” is a symbol representing a current rate. At a current rate of 1 C, the rated capacity of the evaluation cell is passed over one hour.

Charging and discharging with the rectangular wave of FIG. 2 as one cycle was repeated. The rate of resistance increase was measured every 1000 cycles. FIG. 3 is a graph showing the results of a high-rate endurance test. The smaller the resistance increase rate is, the better the high-rate resistance is evaluated.

As the permeability coefficient of the positive electrode layer 10 increases, the high-rate resistance tends to increase. In a system in which the electrolyte solution 80 (excessive solution) is present around the positive electrode layer 10, it is considered that the electrolyte solution 80 flowing out from the positive electrode layer 10 is effectively used by promoting the entry and exit of the electrolyte solution 80 with respect to the positive electrode layer 10.

On the other hand, in a system in which the electrolyte solution 80 (excess liquid) does not exist around the positive electrode layer, it is considered to be effective in suppressing an increase in the resistance increase rate that the electrolyte solution 80 does not flow out from the positive electrode layer 10 as much as possible. In a system in which the electrolyte solution does not exist around the positive electrode layer 10, it is considered that the electrolyte solution flowing out from the positive electrode layer 10 does not easily return to the positive electrode layer 10. It is considered that when the electrolyte solution 80 flows out from the positive electrode layer 10, the electrolyte solution 80 in the positive electrode layer 10 continues to decrease. The decrease in the electrolyte solution 80 (Li ions) in the positive electrode layer 10 can promote an increase in resistance. Therefore, in some embodiments, in a system in which the electrolyte solution does not exist around the positive electrode layer 10, it is considered that the permeability coefficient of the positive electrode layer 10 is desirably small.

For example, the electrolyte solution may move vertically downward under the action of gravity. For example, when the stacking direction is along the vertical direction, it is considered that the first region 51 may be a system in which the electrolyte solution 80 does not exist around the positive electrode layer 10. The second region 52 and the third region 53 may be a system in which the electrolyte solution 80 exists around the positive electrode layer 10. Therefore, by adopting a structure in which the permeability coefficient of the positive electrode layer 10 in the first region 51 is smaller than the permeability coefficients of the positive electrode layer 10 in the second region 52 and the third region 53, improvement in high-rate resistance is expected.

### Second Experiment (for the Permeability Coefficient of the Positive Electrode Layer)

As the density of the positive electrode layer 10 decreases, the amount of voids in the positive electrode layer 10 increases and the permeability coefficient may increase. However, conventionally, a decrease in density leads to a decrease in capacity. Therefore, the present embodiment proposes a structure in which the permeability coefficient is increased while reducing the decrease in the density of the positive electrode layer 10.

As described below, three kinds of positive electrode active materials (particles) having different particle sizes are prepared.
Large Particles: D50=7.45 μm
Medium Particles: 2 μm<D50<7.45 μm
Small Particles: D50=2 μm

In No. 1, the positive electrode layer 10 including only the medium particles was simulated. The density of the positive electrode layer 10 is 2.2 g/cm³.

In No. 2, the positive electrode layer 10 containing only small particles was simulated. The density of the positive electrode layer 10 is 3.3 g/cm³.

In No. 3, the positive electrode layer 10 including two kinds of small particles and large particles was simulated. The mixing ratio (mass ratio) is “(small particles):(large particles)=7:3”. The density of the positive electrode layer 10 was 3.3 g/cm³ as in No. 2.

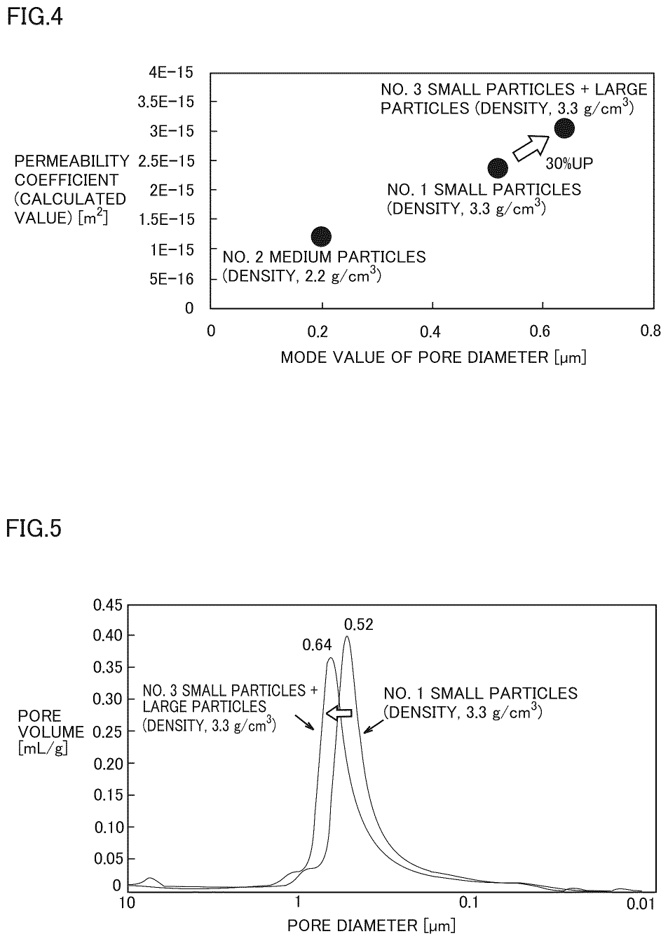

FIG. 4 is a graph showing a correlation between a pore diameter and a permeability coefficient in a positive electrode layer. By mixing the large particles with the small particles, the permeability coefficient is increased by about 30% while maintaining the density. This is probably because relatively large voids may be formed between the large particles and the small particles in the mixed system of the large particles and the small particles. FIG. 5 is a graph showing a first pore size distribution. The first pore size distribution is measured data measured by a mercury porosimeter. In the actual measurement data, the pore size tends to increase in the mixed system of the large particles and the small particles. On the other hand, as shown in FIG. 4, in the single system of the medium particles, the permeability coefficient tends to decrease.

From the results of FIG. 4, it is considered that a mixed system of large particles and small particles is suitable for the positive electrode layer 10 in which a relatively large permeability coefficient is required. It is considered that a single system of the medium particles is suitable for the positive electrode layer 10 in which a relatively small permeability coefficient is required.

Therefore, the positive electrode layer 10 included in the first region 51 is a single system of medium particles. The positive electrode layer 10 included in the second region 52 and the third region 53 is a mixed system of small particles and large particles. That is, the relationship of “d₂<d₁<d₃” is satisfied. When the relationship is satisfied, an improvement in high-rate tolerance is expected.
d₁: particle Size of Medium Particles
d₂: particle Size of Small Particles
d₃: particle size of large particles

### Third Experiment (for Particle Size Ratio “d₃/d₂”)

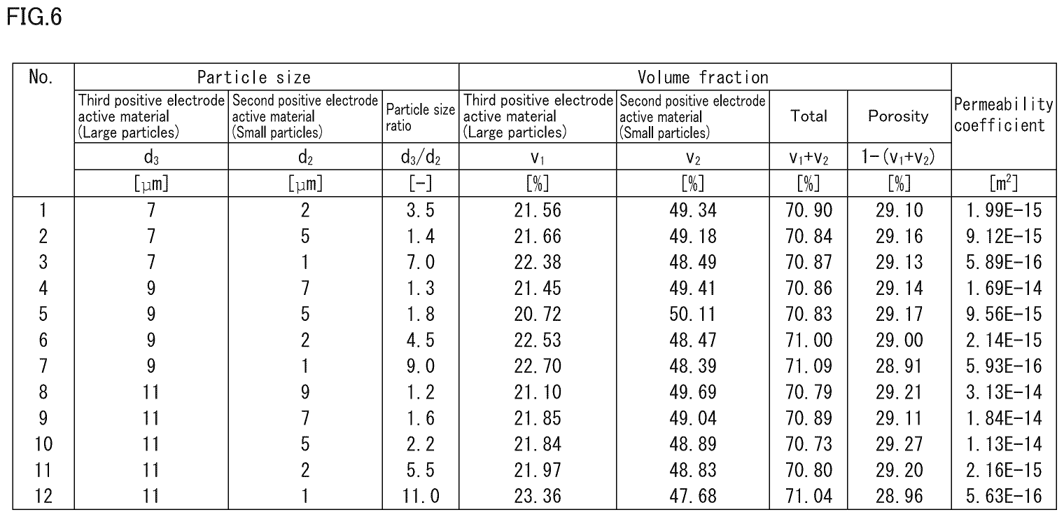

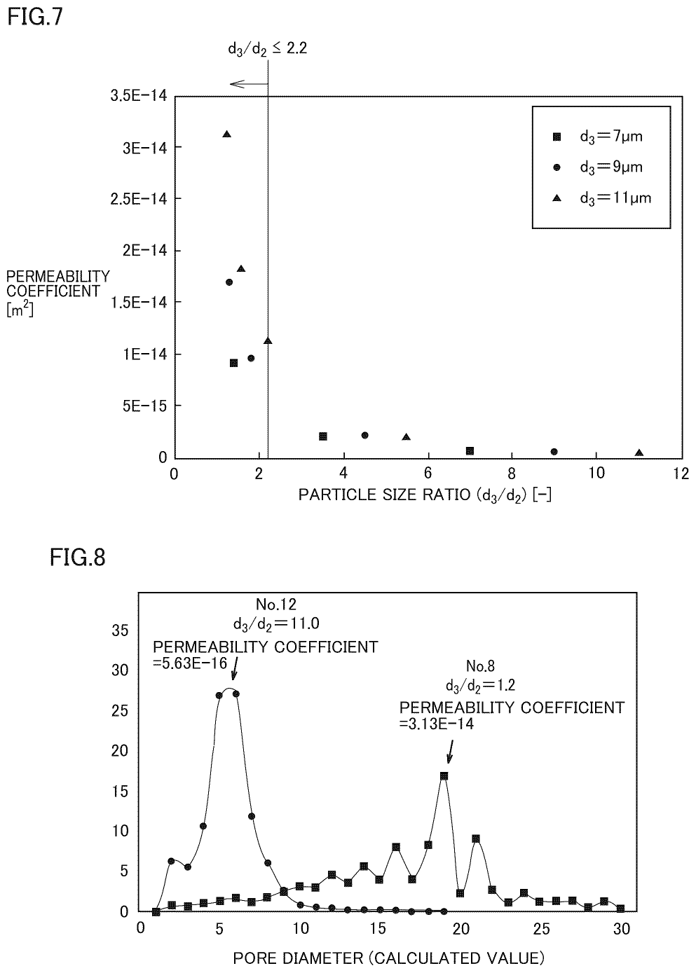

FIG. 6 is a table showing the relationship between the particle size ratio and the permeability coefficient in the positive electrode layer. FIG. 7 is a graph showing a relationship between a particle diameter ratio and a permeability coefficient in a positive electrode layer. In FIG. 7, the data of FIG. 6 is plotted. In all of Nos. 1 to 12 of FIG. 6, the capacity, thickness, density, and mixing ratio of the positive electrode layer 10 are common. The mixing ratio is “(small particles):(large particles)=7:3 (mass ratio)”. In FIG. 6 and the like, for example, the description “1.99E−15” indicates “1.99×10⁻¹⁵”.

As shown in FIG. 7, when the particle size ratio “d₃/d₂” of the large particles to the small particles is 2.2 or less, the permeability coefficient tends to be significantly increased. FIG. 8 is a graph showing a second pore size distribution. The second pore size distribution is a calculated value. In the second pore diameter distribution, the pore diameter distributions of No. 8 “d₃/d₂=1.2, permeability coefficient=3.13×10⁻¹⁴” and No. 12 “d₃/d₂=11.0, permeability coefficient=5.63×10⁻¹⁶” in FIG. 6 are shown. The larger the permeability coefficient of the positive electrode layer 10 is, the larger the pore diameter of the peak top in the pore diameter distribution tends to be.

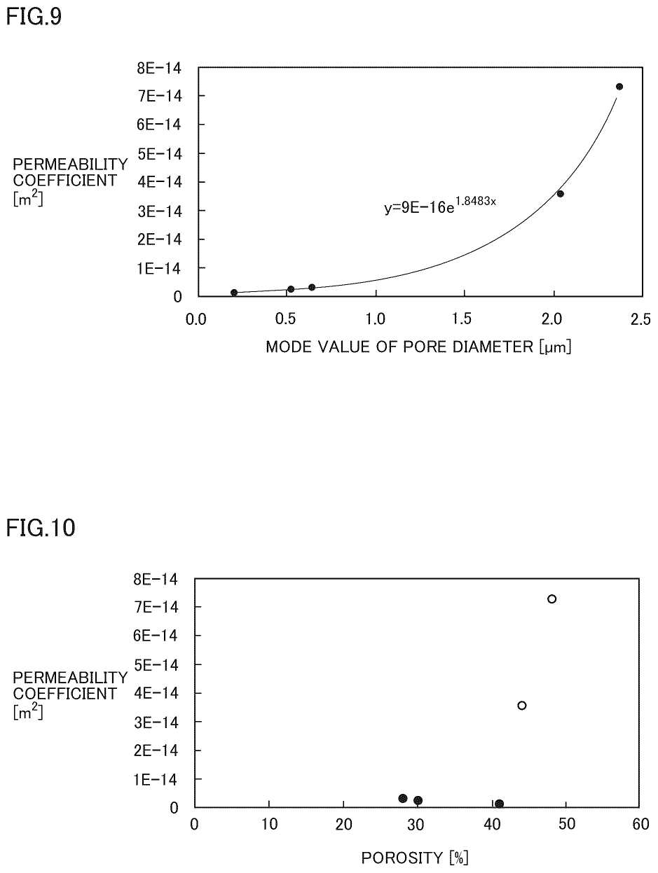

FIG. 9 is a graph showing the correlation between the pore diameter of the positive electrode layer and the permeability coefficient. As shown in FIG. 9, the pore size is considered to have a strong correlation with the permeability coefficient. As the pore size increases, the permeability coefficient tends to increase.

FIG. 10 is a graph showing the correlation between the porosity of the positive electrode layer and the permeability coefficient. As shown in FIG. 10, it is considered that the correlation between the porosity of the positive electrode layer 10 and the permeability coefficient is low.

### Detailed Structure

The particle size ratio “d₃/d₂” may be, for example, 2.0 or less, 1.8 or less, 1.6 or less, 1.5 or less, 1.4 or less, 1.3 or less, or 1.2 or less. The particle size ratio “d₃/d₂” may be, for example, 1.1 or more, 1.2 or more, 1.3 or more, 1.4 or more, 1.5 or more, 1.6 or more, 1.8 or more, or 2.0 or more.

The mixing ratio of the small particles (second positive electrode active material) to the large particles (third positive electrode active material) in mass ratio may be, for example, “(small particles):(large particles)=1:9” to “(small particles):(large particles)=9:1”, or “(small particles):(large particles)=1:9” to “(small particles):(large particles)=4:6”, or “(small particles):(large particles)=2:8” to “(small particles):(large particles)=4:6”.

For example, the relationship of “p₁<p₂” and “p₁<p₃” may be satisfied.
p₁: permeability coefficient of electrolyte solution with respect to positive electrode layer 10 in first region 51
p₂: permeability coefficient of electrolyte solution with respect to positive electrode layer 10 in second region 52
p₃: permeability coefficient of electrolyte solution with respect to positive electrode layer 10 in third region 53

For example, the relationships of “1×10⁻¹⁶ m²<p₁<1×10⁻¹⁴ m²”, “1×10⁻¹⁴ m²≤p₂<1×10⁻¹³ m²” and “1×10⁻¹⁴ m²<p₃<1×10⁻¹³ m²” may be satisfied.

For example, the relationship “1×10⁻¹⁴ m²<pₙ<1×10⁻¹³ m²” may be satisfied.
pₙ: permeability coefficient of electrolyte solution with respect to negative electrode layer 20 in second region 52 and third region 53

The electrolyte solution 80 can also enter and exit the negative electrode layer 20. In the second region 52 and the third region 53 in which the permeability coefficient of the positive electrode layer 10 is large, since the permeability coefficient of the positive electrode layer 10 and the permeability coefficient of the negative electrode layer 20 are equal to each other, improvement in high-rate resistance is expected.

The permeability coefficient “p₂” and the permeability coefficient “p₃” may be, for example, 1.13×10⁻¹⁴ m² or more, 1.69×10⁻¹⁴ m² or more, 1.84×10⁻¹⁴ m² or more, or 3.13×10⁻¹⁴ m² or more. The permeability coefficient “p₂” and the permeability coefficient “p₃” may independently be, for example, 3.13×10⁻¹⁴ m² or less, 1.84×10⁻¹⁴ m² or less, 1.69×10⁻¹⁴ m² or less, or 1.13×10⁻¹³ m² or less.

For example, the relationship of “1≤n₂≤0.5(n₁+n₂+n₃)” may be satisfied.
n₁: the number of positive electrode layers 10 included in the first region 51 (positive integer)
n₂: the number of positive electrode layers 10 included in the second region 52 (positive integer)
n₃: the number of positive electrode layers 10 included in the third region 53 (positive integer)

The number of layers “n₂” may be, for example, 0.4(n₁+n₂+n₃) or less, 0.3(n₁+n₂+n₃) or less, 0.2(n₁+n₂+n₃) or less, or 0.1(n₁+n₂+n₃) or less. The number of layers “n₂” may be, for example, 2 or more, 3 or more, 4 or more, or 5 or more.

For example, the relationship of “n₁=n₃” may be satisfied. For example, the relationship of “n₂≤(n₁+n₃)” may be satisfied. For example, the relationship of “n₂≥(n₁+n₃)” may be satisfied. For example, the relationship of “0.5(n₁+n₂+n₃)≤(n₂+n₃)” may be satisfied.

The positive electrode layer 10 may be supported by the positive electrode current collector 11. The positive electrode layer 10 may be formed on both surfaces of the positive electrode current collector 11. The positive electrode current collector 11 may include, for example, an aluminum foil or the like. The positive electrode layer 10 may have a thickness of, for example, 10 to 1000 μm. The mass fraction of the positive electrode active material in the positive electrode layer 10 may be, for example, 80 to 99%. The positive electrode active material may have any chemical composition. The positive electrode active material may include, for example, at least one selected from the group consisting of a lithium nickel manganese composite oxide, a lithium nickel aluminum composite oxide, and lithium iron phosphate. The positive electrode layer 10 may further include a binder. The mass fraction of the binder in the positive electrode layer 10 may be, for example, 0.1 to 10%. The binder may have any chemical composition. The binder may contain, for example, polyvinylidene difluoride. The positive electrode layer 10 may further include a conductive material. The mass fraction of the conductive material in the positive electrode layer 10 may be, for example, 0.1 to 10%. The conductive material may have any chemical composition. The conductive material may contain, for example, carbon black or the like.

The negative electrode layer 20 may be supported by the negative electrode current collector 21. The negative electrode layer 20 may be formed on both surfaces of the negative electrode current collector 21. The negative electrode current collector 21 may include, for example, a copper foil or the like. The negative electrode layer 20 may have a thickness of, for example, 10 to 1000 μm. The mass fraction of the negative electrode active material in the negative electrode layer 20 may be, for example, 80 to 99%. The negative electrode active material may have any chemical composition. The negative electrode active material may contain, for example, at least one selected from the group consisting of graphite, silicon oxide, and silicon. The negative electrode layer 20 may further include a binder. The mass fraction of the binder in the negative electrode layer 20 may be, for example, 0.1 to 10%. The binder may have any chemical composition. The binder may contain, for example, styrene-butadiene rubber, carboxymethyl cellulose, or the like. Like the positive electrode layer 10, the negative electrode layer 20 may further contain a conductive material. The separator 30 is a porous film. The separator 30 has electrical insulation properties. The separator may include, for example, polyethylene, polypropylene, or the like. The separator 30 may have a thickness of 5 to 50 μm, for example.

The electrolyte solution 80 is a liquid electrolyte. The density (measured at 25° C.) of the electrolyte solution 80 may be, for example, 1.2×10³ to 1.3×10³ kg/m³. The viscosity (measured at 25° C.) of the electrolyte solution may be, for example, 2×10⁻³ to 4×10⁻³ kg/(m·s). The electrolyte solution includes a Li salt and a solvent. The concentration of the Li salt may be, for example, 0.8 to 1.2 mol/L. The Li salt may contain, for example, LiPF₆. The solvent may include, for example, ethylene carbonate, dimethyl carbonate, ethyl methyl carbonate, or the like. The electrolyte solution 80 may further include an optional additive.

What is claimed is:

1. A lithium ion battery comprising:
an electrolyte solution; and
a stacked electrode assembly, wherein
the stacked electrode assembly includes a positive electrode layer and a negative electrode layer,
the positive electrode layer and the negative electrode layer are alternately stacked in a stacking direction,
in the stacking direction, the stacked electrode assembly includes a first region, a second region, and a third region in this order,
the second region includes an intermediate point in the stacking direction,
the first region includes a first positive electrode active material having a first particle size,
each of the second region and the third region includes a second positive electrode active material having a second particle size and a third positive electrode active material having a third particle size, and
a relationship of d₂<d₁<d₃ is satisfied, where
d₁ represents the first particle size,
d₂ represents the second particle size, and
d₃ represents the third particle size.

2. The lithium ion battery according to claim 1, wherein a relationship of d₃/d₂≤2.2 is satisfied.

3. The lithium ion battery according to claim 1, wherein
relationships of p₁<p₂ and p₁<p₃ are satisfied, where
p₁ represents a permeability coefficient of the electrolyte solution with respect to the positive electrode layer in the first region,
p₂ represents a permeability coefficient of the electrolyte solution with respect to the positive electrode layer in the second region, and
p₃ represents a permeability coefficient of the electrolyte solution with respect to the positive electrode layer in the third region.

4. The lithium ion battery according to claim 1, wherein
a relationship of 1≤n₂≤0.5(n₁+n₂+n₃) is satisfied, where
n₁ represents the number of the positive electrode layers included in the first region,
n₂ represents the number of the positive electrode layers included in the second region, and
n₃ represents the number of the positive electrode layers included in the third region.

5. The lithium ion battery according to claim 3, wherein relationships of:
1×10⁻¹⁶ m²≤p₁<1×10⁻¹⁴ m²;
1×10⁻¹⁴ m²≤p₂<1×10⁻¹³ m²; and
1×10⁻¹⁴ m²≤p₃<1×10⁻¹³ m² are satisfied.
